(19) United States
(12) Patent Application Publication
(10) Pub. No.: US 2012/0198281 A1
(43) Pub. Date: Aug. 2, 2012

(54) VALIDATION RULES FOR PROCESS VALIDATION

(75) Inventor: Amir Weinberg, Ra'anana (IL)

(73) Assignee: VALIRE LTD., Ariel (IL)

(21) Appl. No.: 13/014,736

(22) Filed: Jan. 27, 2011

(51) Int. Cl. G06F 11/07

(52) U.S. Cl. 714/37; 714/E11.029

(57) ABSTRACT

A method for process validation includes receiving from a human user a validation rule. The rule specifies a pattern occurring in a process running on a computerized system, an expected outcome of the pattern, a success action to perform when the expected outcome is realized, and a failure action to perform when the expected outcome is not realized. Upon receiving events corresponding to inputs and outputs of the process running on the computerized system, the validation rule is applied to the events so as to engender one or more of the success and failure actions. A validity of the process is assessed responsively to the one or more of the success and failure actions.

### FIELD OF THE INVENTION

The present invention relates generally to methods, apparatus and software for evaluation of complex computerized systems, and specifically to automated process validation.

### BACKGROUND OF THE INVENTION

Enterprise software applications, such as Enterprise Resource Planning (ERP) systems, are widely used in managing business operations and resources. ERP systems are generally implemented as computer applications, which may run on a central server or be distributed over a network of modular hardware and software units. They are used to consolidate operations of different business functions (such as production, inventory, purchasing, sales, service and finance) and management of assets (human, physical and financial) both within and across the boundaries of the enterprise.

### SUMMARY OF THE INVENTION

Embodiments of the present invention that are described hereinbelow provide methods, apparatus and software for validation of processes, based on definition and processing of validation rules. These embodiments are described hereinbelow with particular reference to business processes that run in an ERP system, but they are similarly applicable in validating complex, computerized processes of other types.

There is therefore provided, in accordance with an embodiment of the present invention, a method for process validation, including receiving from a human user a validation rule. The rule specifies a pattern occurring in a process running on a computerized system, an expected outcome of the pattern, a success action to perform when the expected outcome is realized, and a failure action to perform when the expected outcome is not realized. Events corresponding to inputs and outputs of the process running on the computerized system are received, and the validation rule is applied to the events so as to engender one or more of the success and failure actions. A validity of the process is assessed responsively to the one or more of the success and failure actions.

In a disclosed embodiment, the validation rule is written in a rule language having a syntax defined as:

WHEN the pattern EXPECT the outcome;

IF Success DO the success action; and

IF Failure DO the failure action.

The syntax may include a time frame within which the outcome is expected to occur in order for the rule to be true.

In some embodiments, the events are received from an enterprise software application.

In one embodiment, applying the validation rule includes detecting a first event indicating that the pattern has occurred, and searching backward in time over the events that have been previously received for at least one second event belonging to the expected outcome.

In another embodiment, applying the validation rule includes detecting a first event indicating that the pattern has occurred, and searching forward in time over the events received during a predefined time frame following the first event for at least one second event belonging to the expected outcome. The validation rule may further include searching backward in time over the events that have been previously received for at least one third event belonging to the expected outcome.

There is also provided, in accordance with an embodiment of the present invention, validation apparatus, including a memory, which is configured to store a validation rule, as defined above, received from a human user. A validation processor is coupled to the memory and is configured to receive events corresponding to inputs and outputs of the process running on the computerized system, to apply the validation rule to the events so as to engender one or more of the success and failure actions, and to assess a validity of the process responsively to the one or more of the success and failure actions.

There is additionally provided, in accordance with an embodiment of the present invention, a computer software product, including a computer-readable medium in which program instructions are stored, which instructions, when read by a computer, cause the computer to accept a validation rule, as defined above, from a human user. The instructions cause the computer to receive events corresponding to inputs and outputs of the process running on the computerized system, to apply the validation rule to the events so as to engender one or more of the success and failure actions, and to assess a validity of the process responsively to the one or more of the success and failure actions.

The present invention will be more fully understood from the following detailed description of the embodiments thereof, taken together with the drawings in which:

### BRIEF DESCRIPTION OF THE DRAWINGS

FIG. 1 is a block diagram that schematically shows apparatus for process validation, in accordance with an embodiment of the present invention;

FIG. 2 is a flow chart that schematically illustrates a method for process validation, in accordance with an embodiment of the present invention; and

FIGS. 3 and 4 are timing diagrams that schematically illustrate process validation scenarios, in accordance with embodiments of the present invention.

### DETAILED DESCRIPTION OF EMBODIMENTS

### Validation Rule Language—Overview

Validation of large enterprise applications, such as ERP systems, is typically based on painstaking manual testing of a wide range of synthetic scenarios in order to discover and correct bugs. This sort of manual testing, however, is time-consuming and costly and often fails to catch subtle and less common failures.

Embodiments of the present invention that are described hereinbelow provide methods that facilitate effective automated testing of ERP systems, as well as computerized processes in other complex enterprise applications. These methods are based on validation rules, which are delineated by a human user in a validation rule language having a clear, well-defined syntax and semantics. Once the user has defined a validation rule, a validation processor automatically converts the rule to the form of an executable logical test criterion. The processor receives events corresponding to inputs and outputs of the process under test, and automatically applies the test criterion to these events in order to verify that the process satisfies the rule or, alternatively, to detect failures.

Validation rules in the context of a process in an ERP system may express corresponding business rules, which specify a pattern that may occur in the process and an expected outcome of the pattern. A business rule of this sort might be: “No sales tax should be applied to products sold to customers out of state,” i.e., given the pattern that a sale has been made to a customer whose address is out of state, the expected outcome is that the sales tax on the invoice should be zero. In practice the “outcome” may occur at a time either prior to or following the fulfillment of the pattern, as is explained in greater detail hereinbelow.

In some embodiments, the validation rule language has the following syntax:

WHEN the pattern EXPECT the outcome;
IF Success DO a success action; and
IF Failure DO a failure action.
   Applying this syntax to the sales tax rule mentioned above, the validation rule may become, for example:
WHEN customer address is out of state in sales document
EXPECT zero sales tax in invoice.
   ON SUCCESS add one to success counter.
   ON FAILURE issue alert with failure information.

### Example 1

The syntax may be augmented by a temporal criterion, expressing a time frame within which the outcome is expected to occur in order for the rule to be true:
WHEN the pattern EXPECT the outcome WITHIN a time frame.
   (The success and failure actions are omitted here for brevity.) A validation rule of this type could be, for example:
WHEN a sales document arrives EXPECT arrival of invoice WITHIN ten days.

### Example 2

This validation rule expresses the business rule that an invoice must be issued within ten days of sale.

The two example validation rules presented above may be applied together to events received from an ERP system in order to verify that the invoicing part of the product sale process is defined and operates properly. When a sale event to an out-of-state customer results in issuance of an invoice with zero sales tax within ten days, the validation processor will note the successful outcome of both rules (in a database for future reference, for instance). If there is no invoice event within ten days of the sale event, or if the sales tax amount is wrong, the validation processor will issue an alert to the operator.

The validation rule language described herein provides a simple and intuitive tool with which human users can create validation rules. The language is accompanied by event-handling logic for applying these rules to a process under test. Rule engines and rule languages that are known in the art are action-oriented, i.e., they are generally of the form: “WHEN a pattern occurs, EXECUTE an action.” Such languages cannot easily express the “expectation” that is associated with business process rules and is an integral part of the present validation rule language.

### System Description

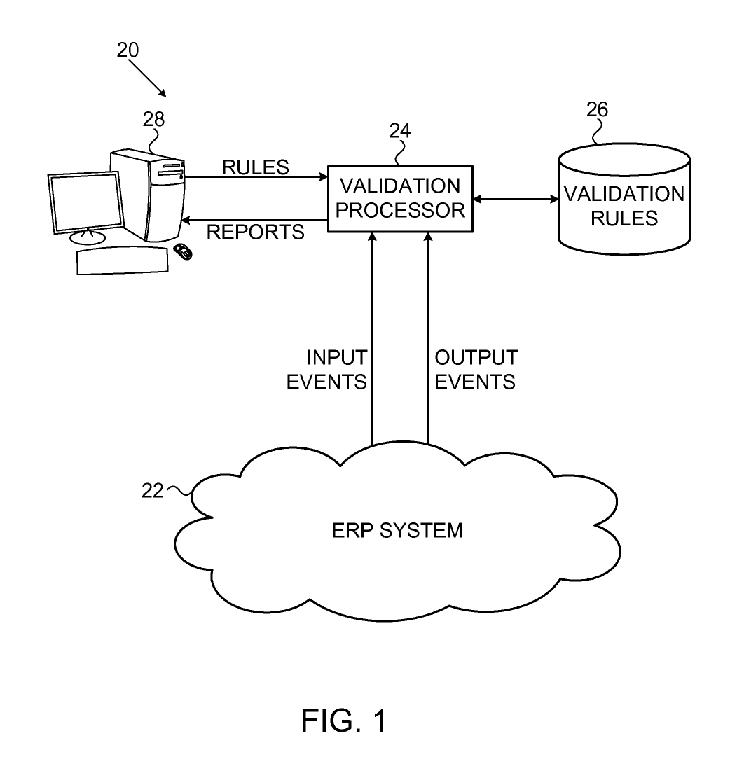

FIG. 1 is a block diagram that schematically illustrates apparatus 20 for validation of a process running in an ERP system 22, in accordance with an embodiment of the present invention. System 22 generates business event data, referred to for simplicity as “events,” corresponding to inputs that the system receives (input events) and outputs that the system generates (output events). For example, an input event might be entry of a sale into system 22 by a sales representative, followed by an output event corresponding to issuance of an invoice by the system. Events are typically accompanied by business data giving relevant process details that are associated with each event.

A validation processor 24 receives these input and output events from system 22 and tests the events against validation rules that are stored in its memory 26. Processor 24 typically comprises a general-purpose computer, which is programmed in software to carry out the functions that are described herein. This software may be downloaded to the computer in electronic form, over a network, for example. Alternatively or additionally, the software may be stored on tangible media, such as optical, magnetic, or electronic memory media.

The validation rules are typically input to processor 24 by a human user via a terminal 28. The user composes the rules in a validation rule language, as described above, possibly using an interactive editing program running on terminal 28, as is known in the art. Validation processor 24 converts the rules from the rule language into executable validation directives, and applies these directives to the event stream from system 22. Processor 24 typically records the validation results in memory 26 and issues reports, including failure alerts, to the user. These reports and alerts may be issued via terminal 28 or via another output device.

### Process Testing Using Validation Rules

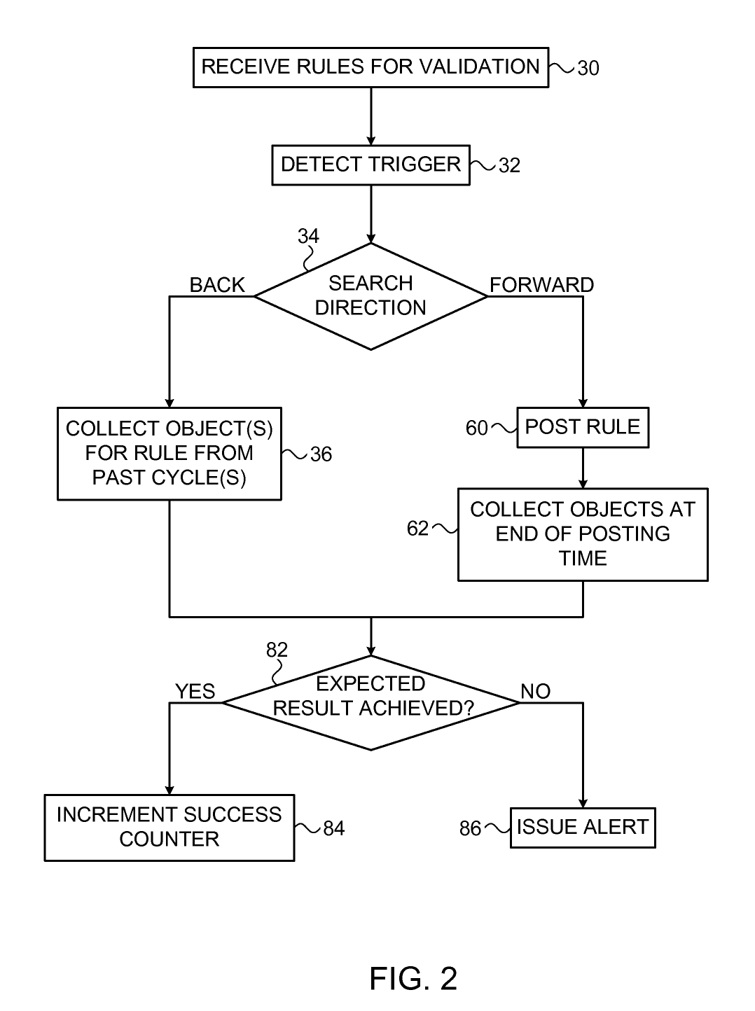

FIG. 2 is a flow chart that schematically illustrates a method for process validation, in accordance with an embodiment of the present invention. The method is described, for the sake of convenience, with reference to ERP system 22 and other components shown in FIG. 1, but it may equally be applied in testing and validation of other types of complex systems and processes, such as customer relations management (CRM), supply chain management (SCM), and billing systems, for example. Although the method is shown and described with reference to processing of a single rule, in practice this method is typically executed by validation processor 24 over multiple rules concurrently.

As the initial step in the validation procedure, processor 24 receives validation rules, at a rule input step 30. The rules are expressed by the user in the validation rule language that is defined above and are converted by processor 24 into executable directives. As noted above, the validation rules have the form: “WHEN the pattern EXPECT the outcome WITHIN a time frame”; and each rule specifies the types of events and data values that constitute the pattern and the outcome and, optionally, the time frame, as well as the actions to be taken on success and failure.

Occurrence of an event pattern serves as the trigger for processor 24 to evaluate the event pattern through the rule, at a trigger detection step 32. Thus, in the rules described above in connection with invoicing of sales, for instance, rule evaluation in Example 1 will be triggered by an output event from ERP system 22 indicating that an invoice has been issued; while in Example 2, the trigger will be an input event to ERP system 22 recording a sale.

Upon receiving the trigger, processor 24 determines whether a forward or backward search is required in order to find data corresponding to the outcome of the rule, at a direction determination step 34. In general, the direction of search is determined by the time frame indicated in the “WITHIN” field of the rule: Processor 24 will search forward in time for the duration indicated by the time frame, but if the duration is null (zero or not specified), the processor will search only backward in time, to find past data corresponding to the specified outcome. Thus, in Example 1, only a backward search is required in order to ascertain the sales tax that was entered in the trigger invoice, whereas in Example 2, processor 24 will search forward (over ten days) for an invoice corresponding to the sale that triggered the search.

When a backward search is triggered, validation processor 24 searches correlated past events and associated data that it has received from ERP system 22, in a backward search step 36. Any suitable sort of data structures and search strategy may be used at this step. In the present embodiment, an object-oriented approach is used, as described below.

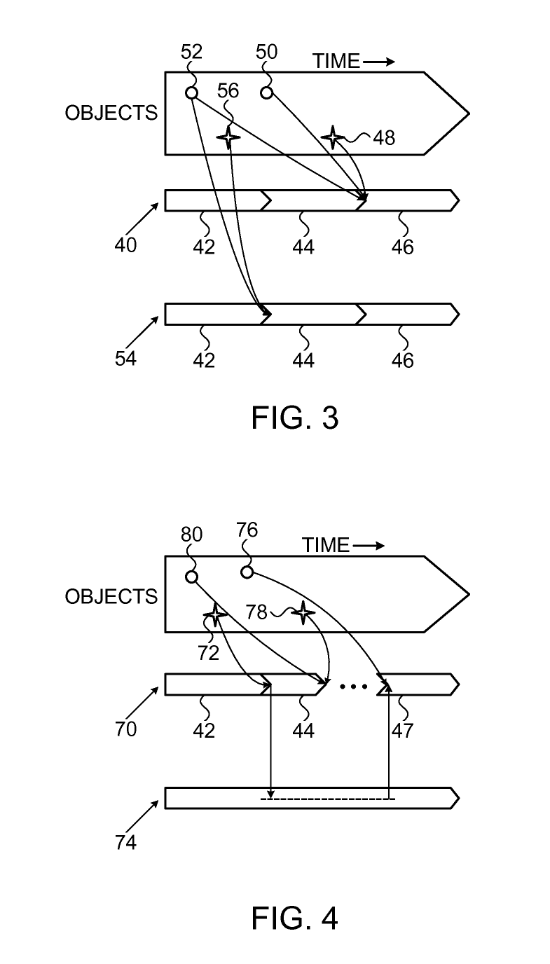

FIG. 3 is a timing diagram that schematically illustrates a process validation scenario involving backward searches of this sort, in accordance with embodiments of the present invention. Validation rules for evaluation by processor 24 are organized into sessions 40, 54, wherein each session contains one or more rules that share similar characteristics, such as triggers, and run over the same body of data. For instance, the two rules listed above as Examples 1 and 2 could run together in an invoicing validation session. Multiple sessions may run in parallel, as illustrated in FIG. 3. For convenience, the sessions are broken into time slots, referred to and shown as cycles 42, 44, 46, . . . . The cycles provide a temporal structure for organizing incoming data and periodically testing the patterns and outcomes of the validation rules in each session.

Validation processor 24 stores events and associated data that it receives from system 22 as objects 48, 50, 52, 56, . . . , in a memory, such as memory 26 or a dedicated event memory (not shown). Each such object is a data structure that holds the relevant items of data and the time of occurrence of the event. Objects that satisfy the “pattern” part of a validation rule are referred to as triggers, or trigger objects, such as objects 48 and in FIG. 3. For validation rules that invoke a backward search, the trigger typically arrives later in time than any other object in the process such as objects 50 and 52, that correspond to the “outcome” part of the rule. Thus, in the rule stated above in Example 1, the arrival of an invoice containing a sales tax field may be used as trigger object 56, which engenders a backward search for object 52, corresponding to the customer address field in the associated sale record. This example demonstrates that a validation rule may involve several objects. Furthermore, a given object (such as object 52 in FIG. 3) may be used as a pattern or outcome in validation of multiple rules and/or in multiple sessions.

In typical operation, at the end of each cycle, processor 24 checks the objects that have been collected during the cycle to identify trigger events (step 32 in FIG. 2). When such a trigger is identified, the processor loads and activates the corresponding validation rule. Thus, in the example shown in FIG. 3, the processor will activate the rule triggered by object 56 at the end of cycle 42 of session 54 and will activate the rule triggered by object 48 at the end of cycle 44 of session 40. The processor will then search for the objects associated with the outcome of the rule over one or more past cycles (step 36 in FIG. 2), such as objects and 52, and will evaluate these objects against the expected outcome of the rule.

Returning now to FIG. 2, if processor 24 determines at step 34 that a rule with a time frame has been triggered, the processor initiates a forward search for the objects corresponding to the outcome of the rule. For this purpose, the processor “posts” the event in question, i.e., it sets an internal timer indicating the number of cycles, corresponding to the time frame of the rule, over which relevant objects will be collected, at a posting step 60. At the end of this posting time, the processor collects and evaluates the relevant objects that have accumulated, at a forward search step 62.

FIG. 4 is a timing diagram that schematically illustrates a process validation scenario involving a forward search of this sort, in accordance with an embodiment of the present invention. The forward search is initiated by a trigger object 72, which processor 24 receives during cycle 42 in a session 70. Upon detecting object 72, processor 24 triggers a posting timer 74, which counts elapsed cycles until the time duration specified by the validation rule in question has expired, in this case at the beginning of a session 47, and then activates the corresponding rule for validation at this point. From this point, processor 24 searches backward for a relevant outcome object 76. Thus, in Example 2 described above, trigger object 72 is a sale event, which causes timer 74 to count forward ten days, after which processor 24 identifies the corresponding invoice as object 76.

A given session may include both forward and backward searches. In the example shown in FIG. 4, session 70 includes a backward search for an object 80 that is triggered by an object 78, in addition to the forward search triggered by object 72. Furthermore, a given validation rule with multiple outcome objects may have a time frame associated with only one (or more) of the outcome objects, while another object or objects have no time frame. In this case, the same rule may engender both backward and forward searches. For example such a rule might be: WHEN customers address is out of state EXPECT (invoice tax=0 AND delivery order WITHIN 10 days). The expected outcome in this case is a group of events with one or more logical operations between them (AND, OR, NOT, XOR, etc.), while the WITHIN time frame acts as a property associated with each one of the events.

By the same token, the pattern of a rule can be a complex set of events with logical operations between them, and can also be another rule (nested rules).

Returning once again to FIG. 2, validation processor 24 evaluates the results of the search performed at step 36 or 62 against the expected outcome of the rule in question, at an evaluation step 82. At this step, the validation processor determines whether all the expected outcome objects (such as an appropriate sales invoices) were found in the search and whether the objects contained the expected result (such as zero sales tax). If so, the processor takes the success action specified by the rule, such as incrementing a success counter in memory 26, at a success step 84. If not, the processor takes the specified failure action, such as issuing an alert with a description of the failure to the user (typically a business user and/or an information technology expert), at a failure step 86.

After completing each pass through the method of FIG. 2, processor 24 continues searching for triggers at step 32 and evaluating the corresponding rules for the duration of the session that the user has specified.

It will thus be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method for process validation, comprising:
receiving from a human user a validation rule specifying:
a pattern occurring in a process running on a computerized system;
an expected outcome of the pattern;
a success action to perform when the expected outcome is realized; and
a failure action to perform when the expected outcome is not realized;
receiving events corresponding to inputs and outputs of the process running on the computerized system;
applying the validation rule to the events so as to engender one or more of the success and failure actions; and
assessing a validity of the process responsively to the one or more of the success and failure actions.

2. The method according to claim 1, wherein the validation rule is written in a rule language having a syntax defined as:
WHEN the pattern EXPECT the outcome;
IF Success DO the success action; and
IF Failure DO the failure action.

3. The method according to claim 2, wherein the syntax comprises a time frame within which the outcome is expected to occur in order for the rule to be true.

4. The method according to claim 1, wherein the events are received from an enterprise software application.

5. The method according to claim 1, wherein applying the validation rule comprises detecting a first event indicating that the pattern has occurred, and searching backward in time over the events that have been previously received for at least one second event belonging to the expected outcome.

6. The method according to claim 1, wherein applying the validation rule comprises detecting a first event indicating that the pattern has occurred, and searching forward in time over the events received during a predefined time frame following the first event for at least one second event belonging to the expected outcome.

7. The method according to claim 6, wherein applying the validation rule further comprises searching backward in time over the events that have been previously received for at least one third event belonging to the expected outcome.

8. Validation apparatus, comprising:
a memory, which is configured to store a validation rule received from a human user, the validation rule specifying:
a pattern occurring in a process running on a computerized system;
an expected outcome of the pattern;
a success action to perform when the expected outcome is realized; and
a failure action to perform when the expected outcome is not realized; and
a validation processor, which is coupled to the memory and is configured to receive events corresponding to inputs and outputs of the process running on the computerized system, to apply the validation rule to the events so as to engender one or more of the success and failure actions, and to assess a validity of the process responsively to the one or more of the success and failure actions.

9. The apparatus according to claim 8, wherein the validation rule is written in a rule language having a syntax defined as:
WHEN the pattern EXPECT the outcome;
IF Success DO the success action; and
IF Failure DO the failure action.

10. The apparatus according to claim 9, wherein the syntax comprises a time frame within which the outcome is expected to occur in order for the rule to be true.

11. The apparatus according to claim 8, wherein the validation processor is coupled to receive the events from an enterprise software application.

12. The apparatus according to claim 8, wherein the validation processor is configured to detect a first event indicating that the pattern has occurred, and to search backward in time over the events that have been previously received for at least one second event belonging to the expected outcome.

13. The apparatus according to claim 8, wherein the validation processor is configured to detect a first event indicating that the pattern has occurred, and to search forward in time over the events received during a predefined time frame following the first event for at least one second event belonging to the expected outcome.

14. The apparatus according to claim 13, wherein the validation processor is further configured backward in time over the events that have been previously received for at least one third event belonging to the expected outcome.

15. A computer software product, comprising a computer-readable medium in which program instructions are stored, which instructions, when read by a computer, cause the computer to accept a validation rule from a human user, the validation rule specifying:
a pattern occurring in a process running on a computerized system;
an expected outcome of the pattern;
a success action to perform when the expected outcome is realized; and
a failure action to perform when the expected outcome is not realized,
wherein the instructions cause the computer to receive events corresponding to inputs and outputs of the process running on the computerized system, to apply the validation rule to the events so as to engender one or more of the success and failure actions, and to assess a validity of the process responsively to the one or more of the success and failure actions.

16. The product according to claim 15, wherein the validation rule is written in a rule language having a syntax defined as:
WHEN the pattern EXPECT the outcome;
IF Success DO the success action; and
IF Failure DO the failure action.

17. The product according to claim 16, wherein the syntax comprises a time frame within which the outcome is expected to occur in order for the rule to be true.

18. The product according to claim 15, wherein the instructions cause the computer to receive the events from an enterprise software application.

19. The product according to claim 15, wherein the instructions cause the computer to detect a first event indicating that the pattern has occurred, and to search backward in time over the events that have been previously received for at least one second event belonging to the expected outcome.

20. The product according to claim 15, wherein the instructions cause the computer to detect a first event indicating that the pattern has occurred, and to search forward in time over the events received during a predefined time frame following the first event for at least one second event belonging to the expected outcome.

21. The product according to claim 20, wherein the instructions further cause the computer backward in time over the events that have been previously received for at least one third event belonging to the expected outcome.
